(19) United States
(12) Patent Application Publication
(10) Pub. No.: US 2013/0211904 A1
(43) Pub. Date: Aug. 15, 2013

(54) GUI That Displays Characteristics of an Advertising Audience Selected By Specifying Targeting Constraints

(71) Applicants: Eric Bax, Altadena, CA (US); Randall Lewis, Santa Clara, CA (US)

(72) Inventors: Eric Bax, Altadena, CA (US); Randall Lewis, Santa Clara, CA (US)

(73) Assignee: Yahoo! Inc., Sunnyvale, CA (US)

(21) Appl. No.: 13/371,113

(22) Filed: Feb. 10, 2012

(51) Int. Cl. G06Q 30/02

(52) U.S. Cl. 705/14.41; 705/14.49; 705/14.66; 705/14.48

(57) ABSTRACT

An audience browser GUI that displays characteristics of an advertising audience selected by specifying targeting constraints is disclosed. The audience browser GUI allows a user to express constraints to define audiences. The audience browser displays characteristics of audiences defined by the constraints. A user can adjust constraints, observe characteristics of the resulting audience, and repeat to develop a desirable audience. In addition, the audience browser may recommend initial constraints and adjustments to constraints, based on advertiser goals and data.

### BACKGROUND

Online advertisers select audiences based on a number of factors, including geography, demographics like age and gender, income level, and interests and behaviors, both declared and observed. To select audiences, advertisers express constraints based on these factors such as, for example “women age 18 to 35 in Iowa.”

Advertisers' end goals may include generating clicks and leads, brand awareness, increasing online sales, and increasing offline sales. Their intermediate goals may include reach, which means showing their ad to as many people as possible within their desired audience, and frequency, which means showing their ads a predetermined number of times to people reached.

Online advertisers face several challenges when selecting audiences. After specifying constraints, advertisers may find it difficult or impossible to estimate the reach, frequency, or performance on end goals for the selected audience. They may also find it difficult to understand the general interests and activities of selected audiences. As advertising campaigns progress, advertisers find it difficult to determine how to adjust targeting constraints to remove under-performing portions of the audience and add new audience members similar to the high-performing ones.

### SUMMARY

Some embodiments of the invention provide a graphical user interface (GUI) which allows an advertiser to specify one or more targeting constraints, wherein the targeting constraints correspond to factors used to select an advertising audience. For example, the factors may include geographic location, demographic information such as age and gender, income level, and interests and behaviors, both declared and observed. For example an advertiser may specify that they want to target men between ages 18-30 who earn $50,000 or more annually. The constraints may be selected by the advertiser using, for example, icons, maps, lists, etc. in the GUI. In addition to specifying the constraints, the advertiser may also indicate whether a selected constraint is a “sharp” constraint or a “fuzzy” constraint. A “sharp” constraint requires an exact match. Whereas a “fuzzy” constraint may not require an exact match. Constraints may be prioritized where not all would necessarily be required to be satisfied exactly, but some would be prioritized in order to customize the delivery patterns of an advertising campaign. For example, a campaign might be primarily targeted at women, but the advertiser may still want a fraction of the campaign to reach men if there is insufficient inventory of ads reaching women.

Characteristics of the audience corresponding to the specified targeting constraints may be displayed graphically in the GUI. The displayed information may be displayed and/or arranged any number of ways and may include icons, drawings, maps, lists, animations, photos, etc. In some embodiments, the audience browser GUI may also display things such as, for example, store locations of the advertiser, locations of the advertiser's competitors, locations of suppliers of complementary goods and services, etc. in order to show the competition landscape for an audience. The advertiser may be allowed to make adjustments to the targeting constraints using the graphical user interface. The adjusted characteristics of the audience corresponding to the adjusted targeting constraints may be displayed graphically in the GU. The advertiser may adjust, or tune any of the constraints and observe how the resulting audience changes. This may advantageously allow advertisers to better estimate the reach, frequency, or performance of end goals for the selected audience.

### BRIEF DESCRIPTION OF THE DRAWINGS

FIG. 1 is a distributed computer system according to one embodiment of the invention;

FIG. 2 is a flow diagram illustrating a method according to one embodiment of the invention;

FIG. 3 is a flow diagram illustrating a method according to one embodiment of the invention;

FIG. 4 is a flow diagram illustrating a method according to one embodiment of the invention; and

FIG. 5 is a block diagram illustrating one embodiment of the invention.

### DETAILED DESCRIPTION

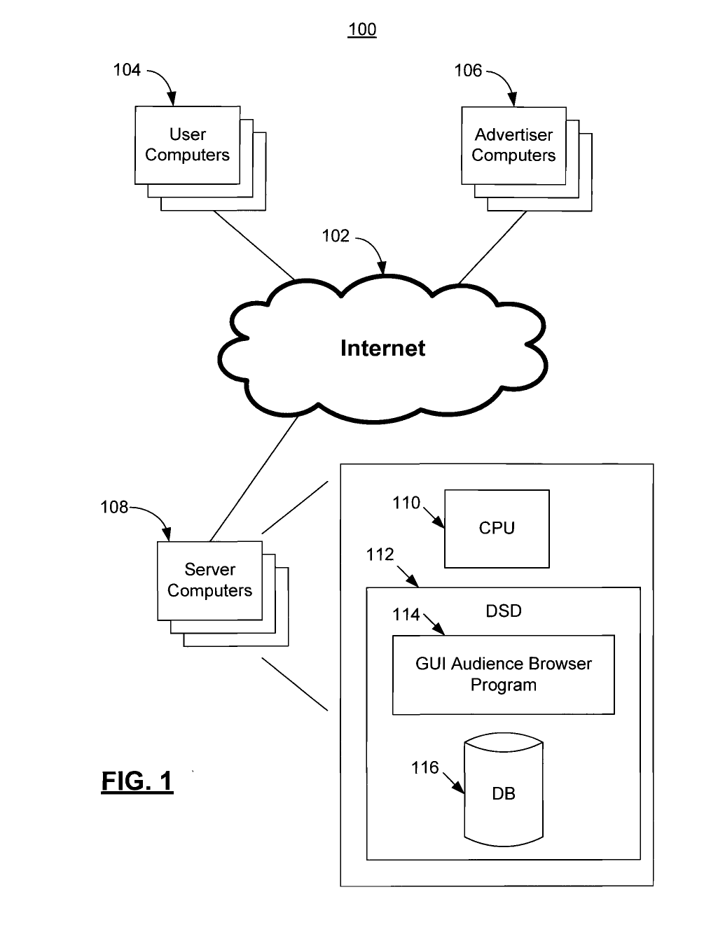

FIG. 1 is a distributed computer system 100 according to one embodiment of the invention. The system 100 includes user computers 104, advertiser computers 106 and server computers 108, all coupled or able to be coupled to the Internet 102. Although the Internet 102 is depicted, the invention contemplates other embodiments in which the Internet is not included, as well as embodiments in which other networks are included in addition to the Internet, including one more wireless networks, WANs, LANs, telephone, cell phone, or other data networks, etc. The invention further contemplates embodiments in which user computers 104 may be or include desktop or laptop PCs, as well as, wireless, mobile, or handheld devices such as cell phones, PDAs, tablets, etc.

Each of the one or more computers 104, 106 and 108 may be distributed, and can include various hardware, software, applications, algorithms, programs and tools. Depicted computers may also include a hard drive, monitor, keyboard, pointing or selecting device, etc. The computers may operate using an operating system such as Windows by Microsoft, etc. Each computer may include a central processing unit (CPU), data storage device, and various amounts of memory including RAM and ROM. Depicted computers may also include various programming, applications, algorithms and software to enable searching, search results, and advertising, such as graphical or banner advertising as well as keyword searching and advertising in a sponsored search context. Many types of advertisements are contemplated, including textual advertisements, rich advertisements, video advertisements, etc.

As depicted, each of the server computers 108 includes one or more CPUs 110 and a data storage device 112. The data storage device 112 includes a database 116 and a Graphical User Interface (GUI) Audience Browser Program 114.

The Program 114 is intended to broadly include all programming, applications, algorithms, software and other and tools necessary to implement or facilitate methods and systems according to embodiments of the invention. The elements of the Program 114 may exist on a single server computer or be distributed among multiple computers or devices.

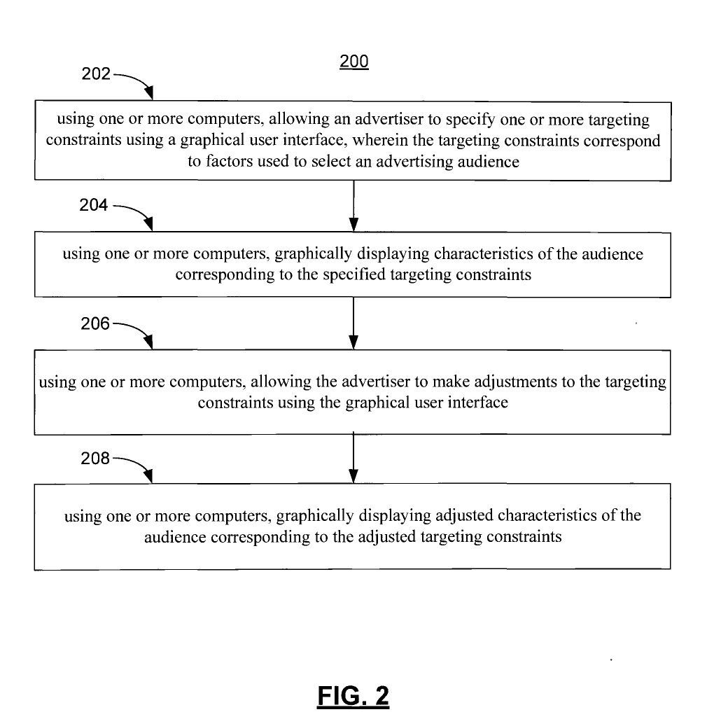

FIG. 2 is a flow diagram illustrating a method 200 according to one embodiment of the invention. At step 202, using one or more computers, an advertiser may be allowed to specify one or more targeting constraints using a graphical user interface (GUI), wherein the targeting constraints correspond to factors used to select an advertising audience. For example, the factors may include, geographic location, demographic information such as age and gender, income level, and interests and behaviors, both declared and observed. For example an advertiser may specify that they want to target men between ages 18-30 who earn $50,000 or more annually. The constraints may be selected by the advertiser using, for example, icons, maps, lists, etc. in the GUI. For example, an advertiser may select areas on a map to specify geographic constraints such as geographic distance to/from a collection of points of interest. In another example, the GUI may include graphical elements such as dials, which may be rotated and/or sliders, which may be moved/dragged to specify values or ranges of values for one or more constraints.

In addition to the factors listed above, the GUI may also allow advertisers to specify and/or visualize constraints such as, for example, expected available advertising inventory for a chosen collection of constraints, impact of changing constraints on inventory pricing, etc. In addition to specifying the constraints, the advertiser may also indicate whether a selected constraint is a “sharp” constraint or a “fuzzy” constraint. A sharp constraint requires an exact match. Whereas a fuzzy constraint may not require an exact match. In some embodiments, the GUI may allow defining the degree of “fuzziness”. In other words, specifying how much a constraint may vary. The GUI may include, for example, a dial that may be rotated or a slider that may be moved to specify the degree of “fuzziness”. Constraints may be prioritized where not all would necessarily be required to be satisfied exactly, but some would be prioritized in order to customize the delivery patterns of an advertising campaign. For example, a campaign might be primarily targeted at women, but the advertiser may still want a fraction of the campaign to reach men if there is insufficient inventory of ads reaching women. In some embodiments, constraints may also include score values calculated using models, simulations, etc. For example, scores may be assigned to audiences for things like “interests in automobiles.” Accordingly, advertisers may, for example, rotate a dial or move a slider to designate a collection of ranges and the “fuzziness” of the boundaries of the ranges of one or more scores. It should be noted that targeting constraints (including financial constraints) may include observations, characteristics, and derivatives (which may be model based, predictions, simulations—machine learning, regression, or methods of imputation) of other information and observations, predictions, etc.

In another example, an advertiser may select cities or towns on a map, and also have the map show similar locations, and allow the user to add or remove locations. In yet another example, an advertiser may select among photos of people that represent certain demographics. In yet another example, an advertiser may select words or phrases from a tag cloud of interests, then see options that further refine or combine concepts from the selected words and phrases, select among those, and repeat until a desired set of interests is displayed.

It should be noted that “map” is not necessarily limited to a geographic map. “Map” may refer to single or multi-dimensional graphical representations of non-geographic abstractions such as “income,” “height v. weight,” “categorical comparisons such as % of each ethnicity joint with % of each gender within each ethnicity and overall,” “joint comparisons of score-based targeting models,” etc. In summary, “map” is merely a graphical representation of the support/domain (in mathematical terms) of two characteristics (continuous, categorical, estimated, etc.) for which you would want to specify constraints that might vary with each other (this may be 1, 2, 3, or higher dimensional). For example, in the height v. weight category, perhaps a particular vendor only wants to sell to tall women who weigh less than 20 lbs per foot. This defines a half-space (or splits the plane between height and weight) diagonally. More complicated transformations and regions (polygons) may be defined on such a space. In the case of weight & height, for example, a transformation such as BMI may be used. This may also refer to a non-geographic representation of the competitive space. For example, “distance” may be interpreted as an abstraction which may refer to physical distance on the face of the earth, but it may also refer to things such as social distance (e.g., targeting friends of friends of friends of a particular demographic), preference distance (e.g., how far is mountain biking from road cycling v. motocross v. ice dancing), etc.

It should be noted that in some embodiments, advertisers may also specify financial constraints such as, for example, the advertiser's willingness to pay. For example, an advertiser may specify bid constraints, which express a limit on the amount to be paid per advertising opportunity or per outcome, such as a click, lead, or sale. As another example, as advertiser may specify budget constraints, which express a limit on the total amount an advertiser is willing to pay for the advertising campaign or a specified subset of the campaign. The audience browser GUI may include these financial constraints in audience definition, displaying, for example, how reach and frequency change as bid or budget increases.

At step 204, using one or more computers, characteristics of the audience corresponding to the specified targeting constraints may be displayed graphically in the GUI. The displayed information may be displayed and/or arranged any number of ways and may include icons, drawings, maps, lists, animations, photos, etc. In some embodiments, the audience browser GUI may also display things such as, for example, store locations of the advertiser, locations of the advertiser's competitors, locations of suppliers of complementary goods and services, etc. in order to show the competition landscape for an audience. The audience browser GUI may also display, for example: locations of home, work, travel, or shopping/entertainment/transaction activity (e.g., stores frequented as determined by GPS, transaction (e.g., credit card records), or other data) for an audience; reach, frequency, or other projected performance characteristics by regions on a map, for example using a heat map; news articles about and/or from locales specified by audience constraints; television shows, films, or other media which are prevalent among a given audience; photos of typical members of the audience; tag clouds indicating audience interests and/or behaviors.

At step 206, using one or more computers, the advertiser may be allowed to make adjustments to the targeting constraints using the graphical user interface. At step 208, using one or more computers, the adjusted characteristics of the audience corresponding to the adjusted targeting constraints may be displayed graphically in the GUI. The advertiser may adjust, or tune any of the constraints and observe how the resulting audience changes. This may advantageously allow advertisers to better estimate the reach, frequency, or performance of end goals for the selected audience.

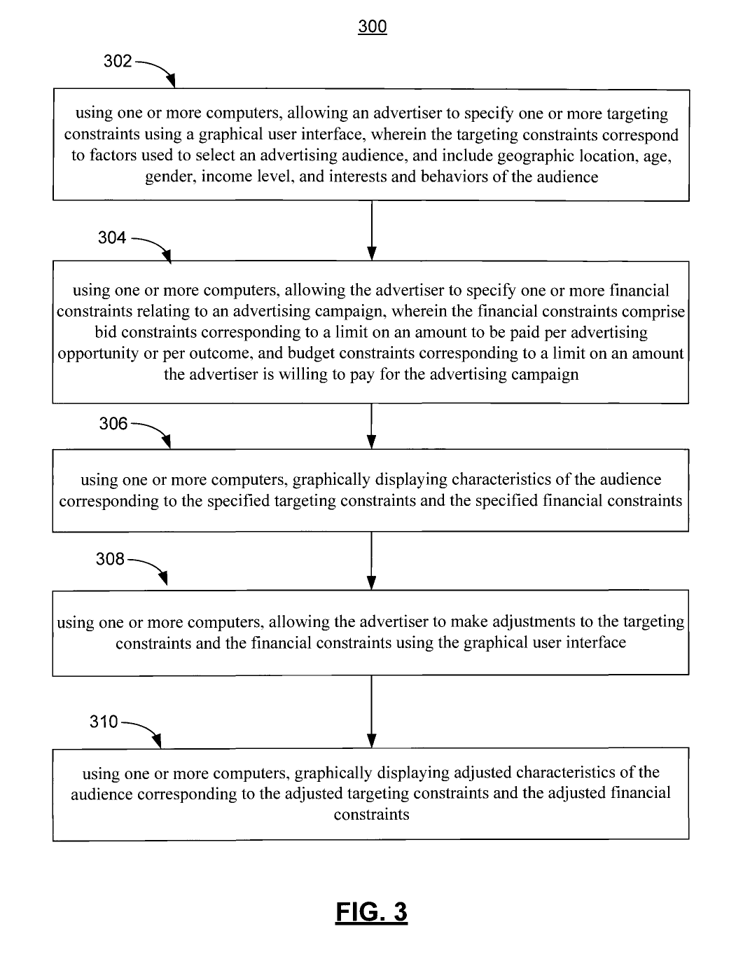

FIG. 3 is a flow diagram illustrating a method 300 according to one embodiment of the invention. At step 302, using one or more computers, an advertiser may be allowed to specify one or more targeting constraints using a graphical user interface, wherein the targeting constraints correspond to factors used to select an advertising audience, and include geographic location, age, gender, income level, and interests and behaviors of the audience. At step 304, using one or more computers, the advertiser may be allowed to specify one or more financial constraints relating to an advertising campaign, wherein the financial constraints comprise bid constraints corresponding to a limit on an amount to be paid per advertising opportunity or per outcome, and budget constraints corresponding to a limit on an amount the advertiser is willing to pay for the advertising campaign.

At step 306, using one or more computers, characteristics of the audience corresponding to the specified targeting constraints and the specified financial constraints may be graphically displayed in the GUI. The displayed information may be displayed and/or arranged any number of ways and may include icons, drawings, maps, lists, animations, photos, etc.

At step 308, using one or more computers, the advertiser may be allowed to make adjustments to the targeting constraints and the financial constraints using the graphical user interface. At step 310, using one or more computers, adjusted characteristics of the audience corresponding to the adjusted targeting constraints and the adjusted financial constraints may be displayed graphically in the GUI.

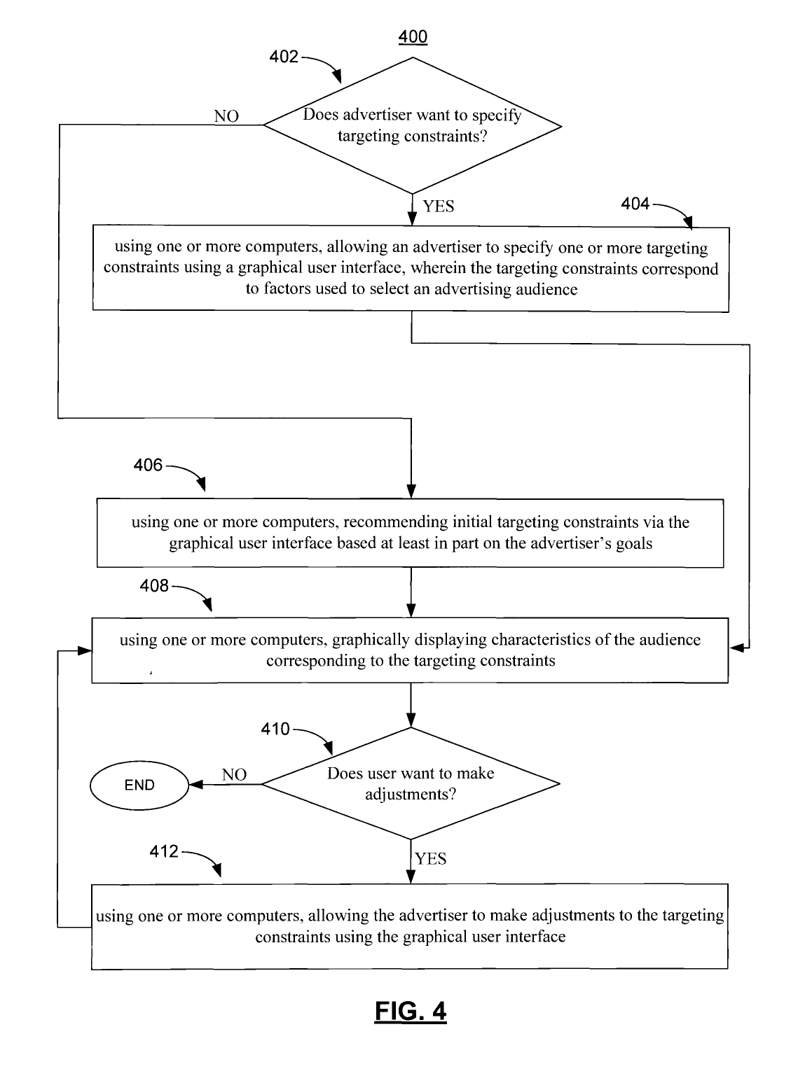

FIG. 4 is a flow diagram illustrating a method 400 according to one embodiment of the invention. At step 402, an advertiser may be asked through the GUI if the advertiser would like to specify targeting constraints. In addition, the advertiser may also be asked if they wanted to specify financial constraints as previously discussed. If the advertiser chooses to specify constraints (targeting and/or financial), at step 404, using one or more computers, the advertiser may be allowed to specify one or more constraints using a graphical user interface, wherein the targeting constraints correspond to factors used to select an advertising audience. If however, the advertiser chooses not to specify constraints, the audience browser GUI may recommend, as shown in step 406, initial targeting constraints based, for example, on the advertiser's goals. In some embodiments, the recommendations may additionally, or alternatively, be based on analysis of data including historical performance of similar advertisements, past performance of the advertising for which the audience is being selected, and projections based on modeling through machine learning or regression. In addition to the recommendations, the audience browser GUI may indicate how the recommendations are likely to affect audience characteristics and cumulative and average campaign performance metrics. The audience browser may be used interactively, as follows: an advertiser may enter goals and information about the advertisements to be shown. The audience browser may recommend an initial set of constraints and display characteristics and projected performance for the resulting audience. The advertiser may then adjust the constraints, as shown in steps 410 and 412, and the audience browser may display changes to audience characteristics and projected performance based on the adjustments (step 408). Alternatively, the advertiser may express desired changes to audience characteristics and performance metrics, and the audience browser may recommend adjustments to achieve those changes. This process may be repeated to develop a desired audience. As the advertising campaign progresses, the process may be used again, based on data from the campaign, to make further adjustments to the audience.

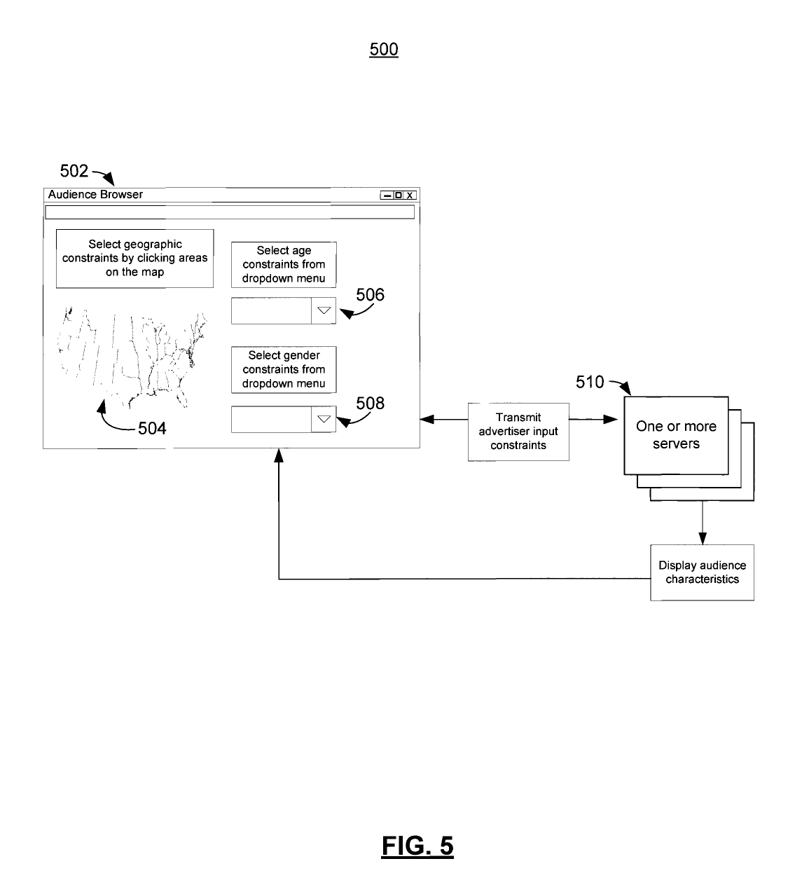

FIG. 5 is a block diagram 500 illustrating one embodiment of the invention. An audience browser GUI 502 in accordance with one embodiment of the invention is depicted. As shown, an advertiser may specify one or more constraints such as, geographic location, age, gender, etc. Although only these three constraints are shown in order to avoid over complicating the drawing, any number of constraints may be specified by the advertiser. The constraints may be specified by, for example, clicking on a map 504, or selecting values from drop down menus 506 and 508. Although FIG. 5 depicts map 504 as a geographic map for illustration purposes, it should be noted that “map” is not necessarily limited to a geographic map. “Map” may refer to single or multi-dimensional graphical representations of non-geographic abstractions such as “income,” “height v. weight,” “categorical comparisons such as % of each ethnicity joint with % of each gender within each ethnicity and overall,” “joint comparisons of score-based targeting models,” etc. In summary, “map” is merely a graphical representation of the support/domain (in mathematical terms) of two characteristics (continuous, categorical, estimated, etc.) for which you would want to specify constraints that might vary with each other (this may be 1, 2, 3, or higher dimensional). Once the advertiser specifies one or more constraints, the GUI may transmit the selections to one or more servers 510. One or more servers 510 may determine how the specified constraints affect the audience and transmit the audience characteristics data to the GUI for display. The advertiser may, based on the displayed audience characteristics, make adjustments to the constraints until the desired audience is reached. In addition, if the advertiser chooses not to specify initial constraints, one or more servers 510 may provide recommendations for an initial set of constraints. The advertiser may then adjust the constraints, and the audience browser may display changes to audience characteristics and projected performance based on the adjustments. Alternatively, the advertiser may express desired changes to audience characteristics and performance metrics, and the audience browser may recommend adjustments to achieve those changes.

While the invention is described with reference to the above drawings, the drawings are intended to be illustrative, and the invention contemplates other embodiments within the spirit of the invention.

1. A method comprising:
using one or more computers, allowing an advertiser to specify one or more targeting constraints using a graphical user interface, wherein the targeting constraints correspond to factors used to select an advertising audience;
using one or more computers, graphically displaying characteristics of the audience corresponding to the specified targeting constraints;
using one or more computers, allowing the advertiser to make adjustments to the targeting constraints using the graphical user interface; and
using one or more computers, graphically displaying adjusted characteristics of the audience corresponding to the adjusted targeting constraints.

2. The method of claim 1, wherein the targeting constraints comprise one or more of geographic location, age, gender, income level, and interests and behaviors.

3. The method of claim 1, further comprising:
using one or more computers, allowing the advertiser to specify the targeting constraints graphically.

4. The method of claim 1, further comprising:
using one or more computers, allowing the advertiser to specify demographic constraints using one or more of numbers, lists, and icons.

5. The method of claim 1, further comprising:
using one or more computers, allowing the advertiser to specify interests and behaviors using one or more of numbers, lists, and icons.

6. The method of claim 1, wherein allowing the advertiser to specify one or more targeting constraints comprises allowing the advertiser to specify whether the targeting constraints are sharp constraints or fuzzy constraints.

7. The method of claim 1, further comprising:
using one or more computers, allowing the advertiser to specify one or more financial constraints.

8. The method of claim 7, wherein the financial constraints comprise one or more of bid constraints corresponding to a limit on an amount to be paid per advertising opportunity or per outcome, and budget constraints corresponding to a limit on an amount the advertising is willing to pay for an advertising campaign.

9. The method of claim 1, further comprising:
using one or more computers, recommending initial targeting constraints via the graphical user interface based at least in part on the advertiser's goals; and
using one or more computers, graphically displaying how the recommended targeting constraints will affect advertising campaign performance metrics.

10. A system comprising:
one or more server computers coupled to a network; and
one or more databases coupled to the one or more server computers;
wherein the one or more server computers are for:
allowing an advertiser to specify one or more targeting constraints using a graphical user interface, wherein the targeting constraints correspond to factors used to select an advertising audience;
graphically displaying characteristics of the audience corresponding to the specified targeting constraints;
allowing the advertiser to make adjustments to the targeting constraints using the graphical user interface; and
graphically displaying adjusted characteristics of the audience corresponding to the adjusted targeting constraints.

11. The system of claim 10, wherein the targeting constraints comprise one or more of geographic location, age, gender, income level, and interests and behaviors of the audience.

12. The system of claim 10, wherein the one or more server computers are further configured for:
allowing the advertiser to specify the targeting constraints graphically.

13. The system of claim 10, wherein the one or more server computers are further configured for:
allowing the advertiser to specify demographic constraints using one or more of numbers, lists, and icons.

14. The system of claim 10, wherein the one or more server computers are further configured for:
allowing the advertiser to specify interests and behaviors using one or more of numbers, lists, and icons.

15. The system of claim 10, wherein allowing the advertiser to specify one or more targeting constraints comprises allowing the advertiser to specify whether the targeting constraints are sharp constraints or fuzzy constraints.

16. The system of claim 10, wherein the one or more server computers are further configured for:
allowing the advertiser to specify one or more financial constraints.

17. The system of claim 16, wherein the financial constraints comprise one or more of bid constraints corresponding to a limit on an amount to be paid per advertising opportunity or per outcome, and budget constraints corresponding to a limit on an amount the advertiser is willing to pay for an advertising campaign.

18. The system of claim 10, wherein the one or more server computers are further configured for:
recommending initial targeting constraints via the graphical user interface based at least in part on the advertiser's goals; and
graphically displaying how the recommended targeting constraints will affect advertising campaign performance metrics.

19. The system of claim 18, wherein the initial targeting constraints are selected based at least in part on projections based on modeling using machine learning or regression techniques.

20. A computer readable medium or media containing instructions for executing a method comprising:
using one or more computers, allowing an advertiser to specify one or more targeting constraints using a graphical user interface, wherein the targeting constraints correspond to factors used to select an advertising audience, and include geographic location, age, gender, income level, and interests and behaviors of the audience;
using one or more computers, allowing the advertiser to specify one or more financial constraints relating to an advertising campaign, wherein the financial constraints comprise bid constraints corresponding to a limit on an amount to be paid per advertising opportunity or per outcome, and budget constraints corresponding to a limit on an amount the advertiser is willing to pay for the advertising campaign;
using one or more computers, graphically displaying characteristics of the audience corresponding to the specified targeting constraints and the specified financial constraints;
using one or more computers, allowing the advertiser to make adjustments to the targeting constraints and the financial constraints using the graphical user interface; and
using one or more computers, graphically displaying adjusted characteristics of the audience corresponding to the adjusted targeting constraints and the adjusted financial constraints.
